(19) United States
(12) Patent Application Publication
(10) Pub. No.: US 2021/0065054 A1
(43) Pub. Date: Mar. 4, 2021

(54) PRIORITIZING TASKS OF DOMAIN EXPERTS FOR MACHINE LEARNING MODEL TRAINING

(71) Applicant: KONINKLIJKE PHILIPS N.V., Eindhoven (NL)

(72) Inventors: Hongchao Nie, Eindhoven (NL); Richard Vdovjak, Eindhoven (NL)

(21) Appl. No.: 16/924,326

(22) Filed: Jul. 9, 2020

Related U.S. Application Data
(60) Provisional application No. 62/894,990, filed on Sep. 3, 2019.

(51) Int. Cl. G06N 20/00; G06N 7/00; G06F 16/242

(52) U.S. Cl. CPC G06N 20/00; G06F 16/242; G06N 7/005

(57) ABSTRACT

Techniques are described herein for prioritizing tasks of domain experts for machine learning model training. In various embodiments, prediction candidates, such as physiological abnormalities of interest, may be assigned priorities for use in labeling training examples that are to be used to train machine learning model(s). The plurality of training examples may be analyzed to generate a corresponding plurality of preliminary predictions. Each preliminary prediction may include a probability that the respective training example of the plurality of training examples includes at least one of the plurality of prediction candidates. A computing device operated by a domain expert may provide output that presents at least some of the plurality of training examples to the domain expert in a manner selected based on the priorities assigned to the plurality of prediction candidates and the plurality of preliminary predictions.

### TECHNICAL FIELD

Various embodiments described herein are directed generally to artificial intelligence. More particularly, but not exclusively, various methods and apparatus disclosed herein relate to prioritizing tasks of domain experts for machine learning model training.

### BACKGROUND

In a data science workflow, domain experts may create ground truth that is used to train machine learning model(s). For example, domain experts may annotate or “label” individual training examples with observation(s) about the data that makes up the individual training examples. These data and the accompanying labels may then be used to train one or more machine learning models to, for instance, make predictions or classifications from unlabeled data. For example, the labels may be used to fit a machine learning model to the training data.

There may be an imbalance between the data needs of those (e.g., data scientists) training the machine learning models and the ground truth training data available to them. The training data may be over-representative of some labels but under-representative of others. Consequently, machine learning models that target (i.e. are trained using training examples labeled with) the under-represented labels may not be adequately trained to make predictions or classifications with acceptable accuracy.

As a non-limiting example, in a batch of training data that includes X-rays of a particular anatomical region, there may be many X-rays that include a first abnormality but relatively few X-rays that include a second, less common abnormality. When domain experts such as radiologists label the training data, if the training examples are presented to the radiologists in a random order, substantially more ground truth data for the first abnormality will be created than for the second abnormality. Consequently, a machine learning model such as a convolutional neural network (“CNN”) being trained to detect the first abnormality may be adequately trained (e.g., sufficiently accurate) and clinically usable long before a second CNN being trained to detect the second abnormality.

### SUMMARY

The present disclosure is directed to methods and apparatus for prioritizing tasks of domain experts for machine learning model training. For example, in various embodiments, training data may be retrieved and/or organized in a manner such that domain experts are presented with those training examples that are most likely going to address current data needs of one or more data scientists and/or machine learning models under training. At least one advantage of prioritizing domain experts' labeling tasks is that machine learning models that are meant to predict and/or classify relatively rare or infrequent features can be trained more quickly than if training data is selected at random.

In some embodiments, a plurality of “prediction candidates” (described below, also referred to as “prediction targets”) of machine learning models may be assigned priorities, manually by humans or automatically by one or more computing devices, based on various factors. These factors may include but are not limited to specified needs of data scientist(s), imbalances between training data used to train multiple machine learning models, accuracies of machine learning models intrinsically or relative to other machine learning models, and so forth.

Additionally, a plurality of training examples may be analyzed to generate preliminary predictions about those training examples. Each preliminary prediction may predict, with less accuracy than would normally be desired in a clinical setting, a likelihood/probability that the corresponding training example includes/exhibits some prediction candidate (e.g., a feature, abnormality, characteristic, etc.).

Once the prediction candidates are assigned priorities and the preliminary predictions about the training examples are generated, they can be used together to retrieve and/or organize the training examples for presentation to domain experts, e.g., at a software tool that is operable to annotate or label individual training examples. For example, a domain expert may be presented with a task list of training examples to label. The task list may be sorted by the priorities assigned to the prediction candidates and by the preliminary predictions associated with the training examples. Consequently, the domain expert is more likely to label training examples that will be beneficial for addressing urgent data needs, inaccurate machine learning models, etc.

Generally, in one aspect, a method may include: assigning priorities to a plurality of prediction candidates for use in labeling a plurality of training examples; applying the plurality of training examples as input across a machine learning model to generate a corresponding plurality of preliminary predictions, wherein each preliminary prediction includes a probability that the respective training example of the plurality of training examples includes at least one of the plurality of prediction candidates; and causing one or more output components of a computing device operated by a domain expert to provide output, wherein the output presents at least some of the plurality of training examples to the domain expert in a manner selected based on the priorities assigned to the plurality of prediction candidates and the plurality of preliminary predictions.

In various embodiments, the output presents a subset of the plurality of training examples that are selected based on one or both of the prioritized plurality of prediction candidates and the plurality of preliminary predictions.

In various embodiments, the method may further include determining relative frequencies at which two or more of the plurality of prediction candidates occur among the plurality of training examples. In various embodiments, the assigning is based on the relative frequencies. In various embodiments, a first prediction candidate of the plurality of prediction candidates is assigned a higher priority than a second prediction candidate of the plurality of prediction candidates because the first prediction candidate occurs less frequently in the plurality of training examples than the second prediction candidate.

In various embodiments, the method may further include: formulating a search query based on the priorities assigned to the plurality of prediction candidates and the plurality of preliminary predictions; and searching one or more databases for training examples based on the search query. In various embodiments, the output presents at least some of the plurality of training examples to the domain expert as a list of tasks ranked by the priorities assigned to the plurality of prediction candidates and the plurality of preliminary predictions.

In another related aspect, a method may include: assigning priorities to a plurality of prediction candidates for use in labeling a plurality of training examples; determining a plurality of likelihoods that a plurality of training examples include one or more of the plurality of prediction candidates; and causing one or more output components of a computing device operated by a domain expert to provide output, wherein the output presents at least some of the plurality of training examples to the domain expert in a manner selected based on the priorities assigned to the plurality of prediction candidates and the plurality of likelihoods.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

As used herein, a “prediction candidate” refers to one of multiple possible classifications or predictions that may be contained in output generated based on a machine learning model. A prediction candidate may correspond to an observation made, e.g., by a domain expert, about a training example that is used to annotate or label that example. For example, there may be x (positive integer) possible abnormalities that may be present (and observable by a domain expert) in a particular type of medical image, e.g., X-ray of a particular anatomical region. Each abnormality may correspond to a prediction candidate, and the x possible abnormalities therefore correspond to x prediction candidates. One or more machine learning models may be trained using this training data (once labeled by domain expert(s)) to generate output that predicts the presence/absence of one or more of the prediction candidates. In some cases, a single, binary machine learning model may be trained to predict or detect the presence or absence of a particular prediction candidate. Alternatively, a single machine learning model may be trained to predict or detect multiple probabilities of a plurality of different prediction candidates.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating various principles of the embodiments described herein.

FIG. 1 schematically illustrates an example environment and workflow in which selected aspects of the present disclosure may be implemented, in accordance with various embodiments.

FIG. 2 depicts an example graphical user interface (“GUI”) that may be operated to configure one or more computing systems with selected aspects of the present disclosure.

FIG. 3 depicts an example method for practicing selected aspects of the present disclosure.

FIG. 4 depicts an example computing system architecture.

### DETAILED DESCRIPTION

In a data science workflow, domain experts may create ground truth that is usable to train machine learning model(s). For example, domain experts may annotate or “label” individual training examples with observation(s) about the data that makes up the individual training examples. These labels may then be used to train one or more machine learning models to, for instance, make predictions or classifications from unlabeled data. However, there may be an imbalance between the data needs of those (e.g., data scientists) training the machine learning models and the actual training data available to them. The training data may be over-representative of some labels and under-representative of others. Consequently, machine learning models trained using the under-represented labels may not be adequately trained to make predictions or classifications with acceptable accuracy, or training of these models may be deaccelerated.

In view of the foregoing, various embodiments and implementations of the present disclosure are directed to prioritizing tasks of domain experts for machine learning model training. For example, when a plurality of training examples are presented to a domain expert for annotation/labeling, these training examples may be presented in a manner that is selected using techniques described herein. Accordingly, the domain expert can focus on those training examples that are likely to be most useful, desired, beneficial, and/or requested by data scientists who train one or more machine learning models.

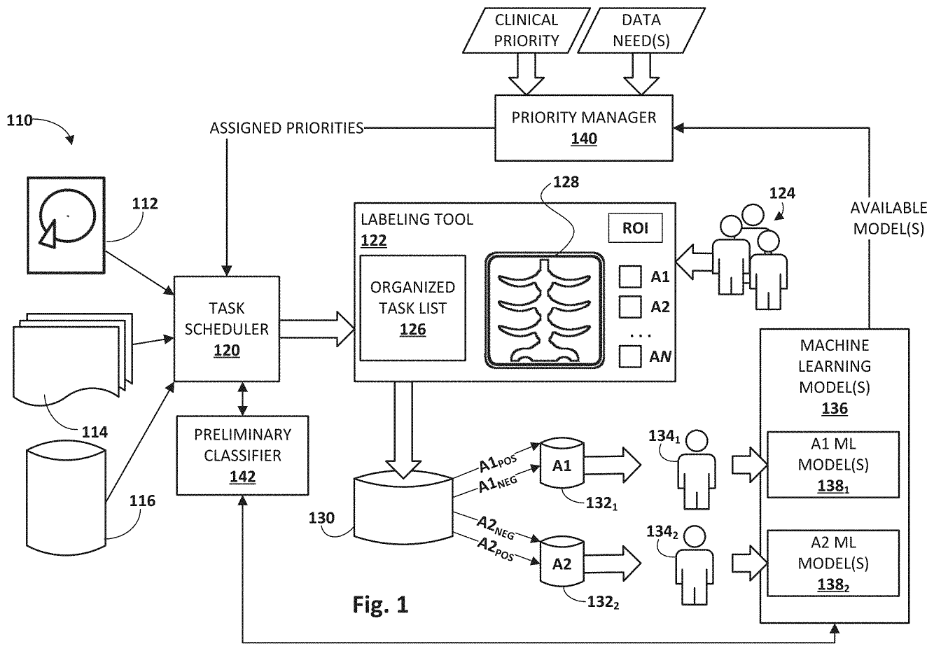

Referring to FIG. 1, a variety of data sources 110 are available from which a plurality of training data can be obtained. In this example, these data sources 110 include one or more computer hard drives 112 from which data can be extracted, for instance, from files, etc. Also present are one or more documents 114, and one or more databases 116 associated with various information systems. In the medical context, data sources 110 may include data sources like electronic medical records (“EMR”), a hospital information system (“HIS”), hospital equipment, etc., and other sources of training data. In some medical contexts, the training data may include medical images such as digital photographs, X-rays, computerized tomography (“CT”) scans, magnetic resonance imaging (“MRI”) scans, digitized slides, or other types of medical images. These images may be stored using various formats, including but not limited to the Picture Archiving and Communication System (“PACS”), the Digital Imaging and Communications in Medicine (“DICOM”), etc.

While examples described herein generally relate to healthcare, this is not meant to be limiting. Techniques described herein may be applicable in any scenario in which machine learning model(s) undergo supervised training to make predictions and/or classifications. Techniques described herein may be applicable to train machine learning models in other contexts, including but not limited to self-driving vehicles, robotics (e.g., object recognition, grasp selection), weather prediction, agricultural analysis, financial analysis, insurance analysis, pattern recognition, facial recognition, voice recognition, and so forth.

In some implementations, a task scheduler 120 may be configured to retrieve and/or organize training data from data sources 110. Task scheduler 120 may provide this retrieved/organized data to a labeling tool 122 operated by one or more domain experts 124. Labeling tool 122 may present the training examples in manner that is determined, e.g., by task scheduler 120, using techniques described herein. For example, labeling tool 122 may present one or more domain experts 124 with an organized task list 126 that presents a ranked or ordered list of training examples. The domain expert(s) 124 may then review and annotate/label the training examples in the order in which they are presented. Consequently, by ranking training examples in this manner, it is possible to ensure that the most needed/requested/beneficial type of training examples are being annotated by domain expert(s) 124.

Components in FIG. 1 such as task scheduler 120 and labeling tool 122, as well as other components such as priority manager 140 and/or preliminary classifier 142, may be implemented using any combination of hardware and/or computer-readable instructions (sometimes referred to as “software”). These components may be implemented across one or more computing systems that may be communicatively coupled via one or more wired or wireless computer networks (not depicted). Additionally or alternatively, these components may be implemented in whole or in part using other forms of logic, including but not limited to an application-specific integrated circuit (“ASIC”), a field-programmable gate array (“FPGA”), and so forth.

In FIG. 1, labeling tool 122 includes a display interface 128 that displays a given training example retrieved from data sources 110. In this example, the training example rendered in display interface 128 takes the form of a chest X-ray, but this is not meant to be limiting. As noted previously, in the medical context, any other types of medical images, such as X-rays of different anatomical regions, CT scans, MRI scans, digitized slides, etc., may be viewed and annotated/labeled by domain expert(s) 124 using labeling tool 122. In the present example, given that the training data takes the form of X-rays, domain expert(s) 124 may be radiologists or other personnel trained to interpret X-rays. In other contexts, training data may take numerous other forms, such as handwriting samples, pictures of objects for which models are being trained to recognize, pictures of objects in various states and/or having various characteristics, etc.

Labeling tool 122 also includes an interface that domain expert(s) 124 can use to select abnormalities A1-AN that are depicted in the training examples. These abnormalities are examples of “prediction candidates” that were discussed previously. If a radiologist detects abnormalities A1 and A2 in a chest X-ray, the radiologist may operate labeling tool 122 to select the boxes A1 and A2. These annotations or labels may be associated with the training example and provided to a training data database 130, e.g., as the domain expert 124 makes them or in batches. In some implementations, labeling tool 122 may also include a region-of-interest (“ROI”) element that, when selected, allows a domain expert to draw or otherwise cause to be selected in display interface 128, a ROI that contains a given abnormality. These ROIs may also be provided to training data database 130.

As a consequence of the processes described above, training data database 130 accumulates, as training data, images, associated annotations/labels, and associated ROIs (if present). These training data may then be used to train one or more machine learning models to make various predictions or classifications based on unlabeled input data. For example, in FIG. 1, training examples that are both positive (A1_{POS}) and negative (A1_{NEG}) for the abnormality A1 may be placed into one bucket 132₁ (e.g., a temporary holding area of memory). Likewise, training examples that are both positive (A2_{POS}) and negative (A2_{NEG}) for the abnormality A2 may be placed into another bucket 1322. While not shown in FIG. 1, other buckets may be provided for other abnormalities.

In some embodiments, the content of buckets 132₁₋₂ may be provided or otherwise made available to respective data scientists 134₁₋₂ or other personnel capable of using annotated/labeled training examples to train machine learning models in a machine learning model library 136. In particular, the data scientists 134₁₋₂ may train one or more machine learning models to predict, detect, or otherwise provide classifications of prediction candidates. For example, the positive and negative A1 training examples are used by an A1 data scientist 134₁ to train an A1 machine learning model 138₁ to generate output that predicts whether the input image includes the prediction candidate A1. Likewise, the positive and negative A2 training examples are used by an A2 data scientist 134₂ to train an A2 machine learning model 138₁. to generate output that predicts whether the input image includes the prediction candidate A2. And so on.

Architectures of machine learning models 138 in library 136 may take various forms, depending on the context, the type of prediction/classification being made, the nature of the training data, the needs of the data scientists 134, etc. These may include, but are not limited to, various types of artificial neural networks, such as a convolutional neural network (“CNN”), a feed-forward neural network (“FFNN”), a generative adversarial neural network (“GAN”), a recurrent neural network (“RNN”) (which may include long short-term memory (“LSTM”) networks or gated recurrent unit (“GRU”) networks), transformer neural networks (“TNN”), and so forth. In contexts in which training examples take the form of two-dimensional images, such as the medical examples described herein, CNN's may be particularly common in library 136, though not exclusive.

Although FIG. 1 depicts distinct data scientists 13412 training distinct models 13812, this is not meant to be limiting. In various embodiments, one data scientist (or a single team of data scientists) may train multiple machine learning models 138. Additionally or alternatively, in FIG. 1, a single model 138 is trained to detect or predict a single abnormality—or more generally, a single prediction candidate—but this is not meant to be limiting. In various embodiments, a single machine learning model may be trained to predict multiple different prediction candidates. For example, a single machine learning model may be trained to generate output that includes a plurality of probabilities corresponding to a plurality of prediction candidates, such as A1-AN.

Priority manager 140 may be configured to assign priorities to a plurality of prediction candidates based on various signals. These priorities may be used, e.g., by task scheduler 120, to determine the manner in which training examples are presented to domain expert(s) 124 in labeling tool 122, e.g., as an organized task list 126. Suppose priority manager 140 determines that the prediction candidate A2 should be assigned the highest priority. Perhaps A2 machine learning model 138₂ has not yet been trained with enough training examples to be considered sufficiently reliable. In some embodiments, priority manager 140 may assign this priority to the prediction candidate A2 targeted by A2 machine learning model 138₂, and may convey this assignment to task scheduler 120.

Task scheduler 120 may then retrieve training examples from data sources 110 and/or organize training examples it retrieves from data sources 110 based on this priority. For example, in some embodiments, task scheduler 120 may formulate a search query that seeks only those training examples that are in some way responsive to the prediction candidate A2 (which the reader will recall corresponds to abnormality A2). Additionally or alternatively, task scheduler 120 may formulate a broader search query, but then may organize (e.g., rank) or even filter the responsive results based on the priority assigned to the prediction candidate A2.

Priority manager 140 may be manually operated and/or may operate autonomously (or at least semi-autonomously). For example, in some implementations, an individual such as a data scientist 134 or another interested party may manually input one or more explicit clinical priorities, which may include, for instance, one or more desired or targeted prediction candidates. The data scientist 134 may determine which clinical priorities to input, for example, based on their own experience in training one or more machine learning models in library 136. For example, a data scientist 134 may determine from his or her own observations that a vast majority of training examples have thus far been A1 positive. Consequently, A2 machine learning model 138₂ may not be sufficiently trained, and the data scientist 134 can manually input a clinical priority that indicates that training examples likely to include prediction candidate A2 should be prioritized over training examples likely to include predication candidate A1.

Additionally or alternatively, priority manager 140 may automatically determine and/or assign priorities to prediction candidates based on various signals. In some embodiments, for instance, priority manager 140 may analyze machine learning models available in library 136 to identify data needs that can be used to determine/assign priorities. As one non-limiting example, counts of training examples used to train each distinct machine learning model 138 in library 136 may be maintained. For example, the counts of training examples in each of buckets 132₁₋₂ may be determined. Priority manager 140 may monitor and/or track these counts. If the count of training examples used to train a first model to predict a first prediction candidate far exceeds a count to train a second model to predict a second prediction candidate, then training examples that are likely to include the second prediction candidate may be prioritized for labeling by domain expert(s) 120 over training examples that are likely to include the first prediction candidate. More generally, in some embodiments, priority manager 140 may monitor respective volumes of training data used to train a library 136 of machine learning models over time, and may rebalance these volumes by adjusting prediction candidate priorities.

In some embodiments, priority manager 140 may balance the volume of training data used to train various machine learning models in library 136 based on user feedback. For example, a user such as a clinician may provide positive or negative feedback about output generated by one or more machine learning models. Priority manager 140 may prioritize training of machine learning models receiving negative feedback over those receiving positive feedback. For example, priority manager 140 may prioritize prediction candidates targeted by poor-performing model(s) over other prediction candidates targeted by well-performing model(s). By assigning higher priorities to prediction candidates targeted by poor-performing model(s), training examples likely to include those prediction candidates are prioritized, e.g., by task scheduler 120, for annotation and/or labeling using labeling tool 122. As a consequence, the poor-performing model(s) may receive additional training more quickly than they might have otherwise.

In some implementations, priority manager 140 may test the accuracy of machine learning models in library 136, e.g., periodically, on demand, after some number of training iterations, etc. In some such implementations, the relative accuracies of multiple machine learning models in library 136 may be used, e.g., by priority manager 140 and/or task scheduler 120, to balance the volume of training data used to train the various machine learning models in library 136. Accuracy of machine learning models may be tested, e.g., by priority manager 140, in various ways.

In some implementations, priority manager 140 may employ cross validation technique(s) to test machine learning models' accuracies. A set of labeled training examples may be divided into two or more subsets. These two or more subsets may include what are often known as a “training” set, a “validation” set, and/or a “testing” or “holdback set. The training subset may be used to fit the machine learning model to the data. The validation set may be used to tune one or more hyper-parameters (e.g., number of hidden layers) of the machine learning model. The testing/holdback set may be used to evaluate the accuracy of the machine learning model. In some embodiments, a ratio of training examples in the training set to training examples in the testing set may be, for instance, 75:25, 80:20, 85:15, 90:10, etc., although other ratios are contemplated.

Once the training data set is used to train the machine learning model—and the validation set is used to tune hyper-parameters where applicable—the testing data set may be applied as input across the machine learning model to generate output. This output may then be compared to the labels applied to the training examples in the training set to determine, in some embodiments, a mean square error (“MSE”) for the testing set. In some cases, the greater a difference between the MSE for the testing data set and an MSE for the training set, the less accurate the machine learning model. Additionally or alternatively, in some embodiments in which a machine learning model generates output indicative of several probabilities of several prediction candidates, the model may not be able to distinguish between multiple prediction candidates, e.g., because their corresponding probabilities are too similar. This may also be evidence that the machine learning model is not sufficiently trained, and/or that more discriminative training data would be beneficial.

As mentioned previously, training examples may be selected and/or organized, e.g., by task scheduler 120, based on (i) the priorities assigned to the plurality of prediction candidates by priority manager 140, and (ii) likelihoods that individual training examples include these prediction candidates. In various embodiments, the likelihood that a given training example will include a particular prediction candidate, such as a medical abnormality visible in an X-ray, may be determined in various ways based on various signals. For example, in some implementations, a preliminary prediction may be made for each of a plurality of training examples. Each preliminary prediction may convey one or more prediction candidates that are likely (e.g., at least to some threshold) included in and/or exhibited by the corresponding training example.

In some embodiments, a preliminary classifier 142 may be configured to analyze training examples and/or data related to training examples to generate preliminary predictions for the training examples. As described previously, in various embodiments, training examples may include images such as digital images, X-rays, CT/MRI scans, digitized slides, etc. Data related or associated with these types of training examples may include, for instance, metadata (e.g., filenames, properties, edit/creation dates, author, source equipment, etc.), or clinical data associated with the training examples in databases such as an HIS.

For example, a given training example image may be associated with a particular patient, who in turn may be associated with various EMRs created by various clinicians. These EMRs may include information about the patient such as diagnoses, treatments, etc. This EMR information may, in some cases, be informative about a likelihood that the training example will include a particular prediction target. This knowledge may be leveraged to make a preliminary prediction about the training example.

Suppose a primary care physician indicates, in an EMR of a patent, a suspicion that the patient has some sort of abnormality or malady. The same physician may order an X-ray or CT scan to conform his or her suspicion. Even before analyzing that resultant X-ray or CT scan, the primary care physician's hypothesis in itself may evidence at least some likelihood that the abnormality or malady is present. Accordingly, preliminary classifier 142 may analyze this data, alone or in combination with the image data of the training example, to generate a preliminary prediction that one or more prediction candidates (e.g., abnormalities) are present in the training example.

In some embodiments, if the preliminary prediction satisfies some threshold, preliminary classifier 142 may preliminarily assign or classify the training example as including the prediction candidate. That training example, along with other preliminarily-classified training examples, may then be organized (e.g., ranked) by task scheduler 120 in accordance with the prediction candidate priorities assigned by priority manager 140. It should be noted that while a patient's identity may be used to connect data from different data sources together, in various embodiments, the patient's identity may be kept anonymous, e.g., to domain expert(s) 124 and/or data scientist(s) 134. For example, preliminary classifier 142 may use the patient's identify to access various records associated with the patient to make a preliminary prediction, but may only provide the preliminary prediction to task scheduler 120 so that task scheduler 120 can organize the training example along with other preliminarily-classified training examples. The patient's identify may be withheld from labeling tool 122, for instance.

In some implementations, preliminary classifier 142 may utilize one or more machine learning models to generate preliminary predictions about training examples. In some cases these machine learning models may be specifically designed to make preliminary predictions using input data extracted from training examples, such as images, metadata, or other data associated with the training examples (which was described previously). For example, various features may be extracted from a training example, including from its metadata, from files or documents associated with the training example (e.g., EMRs of an underlying patient), from images such as X-rays, CT/MRI scans, digitized slides, etc. These extracted features may then be applied as input across one or more machine learning models to generate output that may, for instance, indicate a probability that the training example exhibits one or more prediction candidates.

Additionally or alternatively, in some embodiments, the same machine learning models 138 in library 136 that are undergoing training may also be used to make preliminary predictions. Even though a particular machine learning model 138 may still be undergoing training, it may be accurate enough to at least make a preliminary prediction about whether a given training example exhibits a particular prediction candidate. For example, a currently-in-training model may be used to generate a preliminary probability that a training X-ray exhibits a particular abnormality. So long as this preliminary probability satisfies some minimal threshold, say, 0.4 in a range from 0.0 to 1.0, that training example may be preliminarily classified as exhibiting the particular abnormality. If such a low probability were generated from the same X-ray using a fully-trained model, on the other hand, that low probability would not likely be accepted as evidencing presence of the particular abnormality.

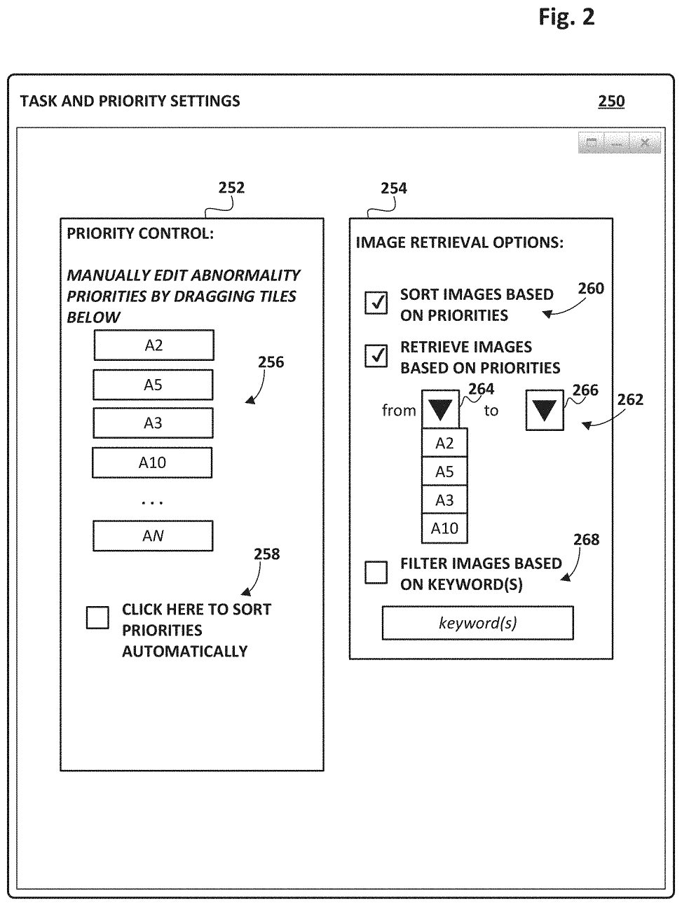

FIG. 2 depicts an example graphical user interface (“GUI”) 250 entitled “Task and Priority Settings.” GUI 250 can be operated by various users, such as a data scientist 134 or a domain expert 124, to change various settings applied by priority manager 140 and/or by task scheduler 120 when these components practice selected aspects of the present disclosure. For example, a first interface 252 allows the user to exert control over how priorities are assigned to prediction candidates. First interface 252 includes a sortable list 256 of icons associated with prediction candidates, which in this example correspond to medical abnormalities A1-AN. In this particular example, the abnormalities are sorted as follows: A2→A5→A3→A10→ . . . . A user may manually select how priorities are assigned to these abnormalities (i.e. prediction candidates) by dragging the icons into whatever order the user desires. Another selectable element 258 gives the user the option of automatically sorting the abnormalities, e.g., based on analysis performed by priority manager 140 as described previously.

GUI 250 also includes a second interface 254 that is operable to select various options relating to how training examples—which in this embodiment are medical images—may be organized and/or retrieve/selected from one or more data sources 110, e.g., based on priorities assigned to prediction candidates by priority manager 140. One selectable element 260 allows the user to select whether images are sorted based on the priorities of preliminary predictions generated from those images, e.g., by preliminary classifier 142. Another operable interface 262 includes two pull-down menus, 264 and 266. Pull down menus 264-266 are operable to allow the user to indicate criteria for which images (or more generally, training examples) are retrieved from data sources 110 for annotation/labeling by domain expert(s) 124 operating labeling tool 122. In this particular example, images preliminarily predicted to have abnormalities in a range from that selected in the first pull down menu 264 to that selected in the second pull down menu 266 are retrieved for annotation/labeling using labeling tool 122. Other images not meeting these criteria are not loaded into labeling tool 122. Consequently, domain expert(s) 124 can focus their efforts on images that are likely to include high-priority (or selected priority) prediction candidate(s).

In some embodiments, rather than retrieving only those training examples that meet certain criteria, all training examples may be retrieved and then training examples that are likely to include desired prediction candidates are filtered presented to domain expert(s) 124. For example, another interface 268 is operable to input one or more keywords that may be used to limit which training examples are presented to domain expert(s) 124 by labeling tool 122. Additionally or alternatively, in some embodiments, users may provide keywords that are used to retrieve pertinent training examples, e.g., from data sources 110. In yet other embodiments, task scheduler 120 and labeling tool 122 may present domain expert(s) 124 with all training examples, but in a ranked order that is dictated by the priorities assigned to the prediction candidates by priority manager 140 and the preliminary classifications made by preliminary classifier 142.

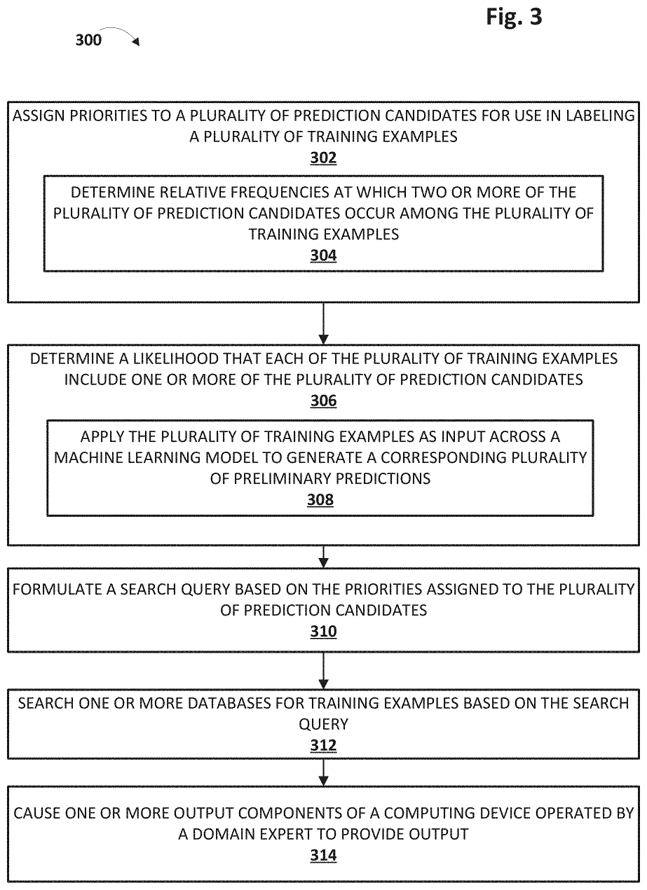

FIG. 3 illustrates a flowchart of an example method 300 for practicing selected aspects of the present disclosure. The steps of FIG. 3 can be performed by one or more processors, such as one or more processors of the various computing devices/systems described herein. For convenience, operations of method 300 will be described as being performed by a system configured with selected aspects of the present disclosure. Other implementations may include additional steps than those illustrated in FIG. 3, may perform step(s) of FIG. 3 in a different order and/or in parallel, and/or may omit one or more of the steps of FIG. 3.

At block 302, the system, e.g., by way of priority manager 140, may assign priorities to a plurality of prediction candidates for use in labeling a plurality of training examples. As noted previously, this assignment may be performed manually, e.g., based on input provided at an interface such as GUI 250, or automatically, e.g., as determined by priority manager 140 based on the various signals described previously.

In some embodiments, the assigning may include, at block 304, determining relative frequencies at which two or more of the plurality of prediction candidates occur among the plurality of training examples. The assigning of block 302 may be based on these relative frequencies. For example, a first prediction candidate of the plurality of prediction candidates may be assigned a higher priority than a second prediction candidate of the plurality of prediction candidates because the first prediction candidate occurs less frequently in the plurality of training examples than the second prediction candidate. Additionally or alternatively, in some embodiments, the assigning of block 302 may be based on other signals described previously, such as relative accuracies of multiple machine learning models (e.g., determined by priority manager 140 using cross validation or other similar techniques), relative counts of training data used to train each machine learning model, manual user input, etc.

At block 306, the system, e.g., byway of preliminary classifier 142, may determine a likelihood that each of the plurality of training examples include one or more of the plurality of prediction candidates. For example, the preliminary classifier may, at block 308, apply the plurality of training examples as input across one or more machine learning models to generate a corresponding plurality of preliminary predictions. Each preliminary prediction may include a probability that the respective training example of the plurality of training examples includes at least one of the plurality of prediction candidates. In some embodiments, the training examples may be applied across an ensemble of machine learning models that are arranged in a manner selected to identify which prediction candidates are most likely contained in each training example.

As noted previously, when retrieving training examples for labeling by domain expert(s) 124, the system may retrieve all preliminarily-classified training examples and then filter them according to the priorities assigned to the prediction candidates, or the system may retrieve only those preliminarily-classified training examples that satisfy criteria relating to the priorities assigned to the prediction candidates (e.g., retrieve only training examples for the n highest priority prediction candidates). In embodiments that take the latter approach, at block 310, the system, e.g., by way of task scheduler 120, may formulate a search query based on the priorities assigned to the plurality of prediction candidates by priority manager 140 and the plurality of preliminary predictions generated by preliminary classifier 142. In some such embodiments, at block 312, the system may search one or more databases (e.g., 312-316) for training examples based on the search query. For example, the system may search preliminarily-classified training examples for those that have been preliminarily classified as including relatively high priority prediction candidates. In embodiments that take the former approach (retrieve all training examples and then filter and/or rank), blocks 310-312 may be omitted.

At block 314, the system may cause one or more output components of a computing device operated by a domain expert 124—and in particular, task scheduler 120—to provide output. In various embodiments, the output may present at least some of the plurality of training examples to the domain expert 124 in a manner selected based on the priorities assigned to the plurality of prediction candidates at block 302 and the plurality of preliminary predictions made at block 306-308. In some embodiments, the output may present a subset of the plurality of training examples that are selected based on one or both of the prioritized plurality of prediction candidates and the plurality of preliminary predictions. Additionally or alternatively, in some embodiments, the output presents at least some of the plurality of training examples to the domain expert as a list of tasks ranked by the priorities assigned to the plurality of prediction candidates and the plurality of preliminary predictions.

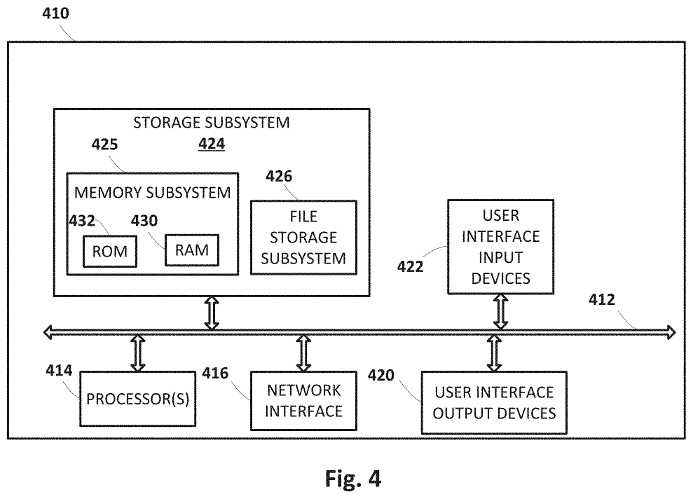

FIG. 4 is a block diagram of an example computing device 410 that may optionally be utilized to perform one or more aspects of techniques described herein. Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In some implementations in which computing device 410 takes the form of a HMD or smart glasses, a pose of a user's eyes may be tracked for use, e.g., alone or in combination with other stimuli (e.g., blinking, pressing a button, etc.), as user input. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, one or more displays forming part of a HMD, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the method(s) described herein, as well as to implement various components depicted in FIG. 1.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented byway of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

What is claimed is:

1. A method implemented using one or more processors, comprising:
assigning priorities to a plurality of prediction candidates for use in labeling a plurality of training examples;
applying the plurality of training examples as input across a machine learning model to generate a corresponding plurality of preliminary predictions, wherein each preliminary prediction includes a probability that the respective training example of the plurality of training examples includes at least one of the plurality of prediction candidates; and
causing one or more output components of a computing device operated by a domain expert to provide output, wherein the output presents at least some of the plurality of training examples to the domain expert in a manner selected based on the priorities assigned to the plurality of prediction candidates and the plurality of preliminary predictions.

2. The method of claim 1, wherein the output presents a subset of the plurality of training examples that are selected based on one or both of the prioritized plurality of prediction candidates and the plurality of preliminary predictions.

3. The method of claim 1, further comprising determining relative frequencies at which two or more of the plurality of prediction candidates occur among the plurality of training examples.

4. The method of claim 3, wherein the assigning is based on the relative frequencies.

5. The method of claim 4, wherein a first prediction candidate of the plurality of prediction candidates is assigned a higher priority than a second prediction candidate of the plurality of prediction candidates because the first prediction candidate occurs less frequently in the plurality of training examples than the second prediction candidate.

6. The method of claim 1, further comprising:
formulating a search query based on the priorities assigned to the plurality of prediction candidates and the plurality of preliminary predictions; and
searching one or more databases for training examples based on the search query.

7. The method of claim 1, wherein the output presents at least some of the plurality of training examples to the domain expert as a list of tasks ranked by the priorities assigned to the plurality of prediction candidates and the plurality of preliminary predictions.

8. At least one non-transitory computer-readable medium comprising instructions that, in response to execution of the instructions by one or more processors, cause the one or more processors to perform the following operations:
assigning priorities to a plurality of prediction candidates for use in labeling a plurality of training examples;
determining a plurality of likelihoods that a plurality of training examples include one or more of the plurality of prediction candidates; and
causing one or more output components of a computing device operated by a domain expert to provide output, wherein the output presents at least some of the plurality of training examples to the domain expert in a manner selected based on the priorities assigned to the plurality of prediction candidates and the plurality of likelihoods.

9. The at least one non-transitory computer-readable medium of claim 8, wherein the determining comprises applying the plurality of training examples as input across a machine learning model to generate a corresponding plurality of preliminary predictions, wherein each preliminary prediction includes a likelihood that the respective training example of the plurality of training examples includes at least one of the plurality of prediction candidates.

10. The at least one non-transitory computer-readable medium of claim 8, wherein the output presents a subset of the plurality of training examples that are selected based on one or both of the prioritized plurality of prediction candidates and the plurality of preliminary predictions.

11. The at least one non-transitory computer-readable medium of claim 8, further comprising instructions for determining relative frequencies at which two or more of the plurality of prediction candidates occur among the plurality of training examples.

12. The at least one non-transitory computer-readable medium of claim 11, wherein the assigning is based on the relative frequencies.

13. The at least one non-transitory computer-readable medium of claim 12, wherein a first prediction candidate of the plurality of prediction candidates is assigned a higher priority than a second prediction candidate of the plurality of prediction candidates because the first prediction candidate occurs less frequently in the plurality of training examples than the second prediction candidate.

14. The at least one non-transitory computer-readable medium of claim 8, further comprising instructions for:
formulating a search query based on the priorities assigned to the plurality of prediction candidates and the plurality of likelihoods; and
searching one or more databases for training examples based on the search query.

15. A system comprising one or more processors and memory storing instructions that, in response to execution of the instructions by the one or more processors, cause the one or more processors to:
assign priorities to a plurality of prediction candidates for use in labeling a plurality of training examples;
determine a plurality of probabilities that a plurality of training examples include one or more of the plurality of prediction candidates; and
cause one or more output components of a computing device operated by a domain expert to provide output, wherein the output presents at least some of the plurality of training examples to the domain expert in a manner selected based on the priorities assigned to the plurality of prediction candidates and the plurality of probabilities.
